(19) United States
(12) Patent Application Publication
(10) Pub. No.: US 2011/0102583 A1
(43) Pub. Date: May 5, 2011

(54) REAR VIEW CAMERA SYSTEM AND CALIBRATION METHOD

(76) Inventor: Kim Kinzalow, Sweetwater, TN (US)

(21) Appl. No.: 12/619,906

(22) Filed: Nov. 17, 2009

Related U.S. Application Data
(60) Provisional application No. 61/256,650, filed on Oct. 30, 2009.

(51) Int. Cl. H04N 7/18

(52) U.S. Cl. 348/137; 348/148; 348/E07.085

(57) ABSTRACT

A method for calibrating a rear view camera system provides a driver with an accurate and effective aid for backing a vehicle. The rear view camera system includes a closed circuit video camera connected to a video monitor mounted in the driver's area. A marker is placed a known distance from the rear of the vehicle. The system is calibrated by adjusting a horizontal rear scale line up and down on the monitor so that it coincides with the edge of the marker. Once the system is calibrated, as the vehicle is backed and the rear scale line contacts an object on the monitor, the driver knows that the vehicle is the known distance from the rear bumper of the vehicle.

### CROSS REFERENCE TO RELATED APPLICATIONS

This non-provisional utility application claims priority from provision patent application Ser. No. 61/256,650, filed Oct. 30, 2009 and titled “Rear View Camera System and Calibration Method,” which is incorporated herein by reference in its entirety.

### FIELD

This disclosure relates to the field of rearview camera systems for vehicles. More particularly, this disclosure relates to a rearview camera system and method for calibrating the same.

### BACKGROUND

Rear view camera systems of various configurations and components help drivers back or reverse with easy vision to the rear of the vehicle. Such systems help minimize dangers when backing such as striking a person, animal or stationary object such as a parked vehicle or loading dock. Typical systems have one or more mounted closed-circuit video cameras connected to monitors mounted within a driver's cabin. The monitors can be mounted on the ceiling of the cabin or the windshield of the cabin, rest on the dashboard, or be integrated in the face of the instrument panel of the cabin.

Referring to FIG. 1, a prior art screenshot of the video monitor of a rear view camera system is shown. As shown, the system includes the option of displaying multiple rear scale lines 2 over the image 4 received from the video camera. Each of the lines shown on the monitor corresponds to a supposed distance from the rear of the vehicle. As the driver backs the vehicle, he or she is able to discern the relative distance particular objects are from the rear of the vehicle. However, these rear scale lines are not calibrated and are generally very inaccurate concerning the actual distance from the vehicle to objects in the field of vision. One problem arises because the distance (representing the rear of the vehicle to an object) corresponding to a particular line remains constant on the monitor, but the actual distance to the object changes depending on the mounting height of the video camera. The lines in these prior art systems are fixed on the screen and therefore cannot be calibrated to account for such inaccuracies. Thus, a rear view camera system is needed that can be calibrated to provide accurate information concerning the distance from the rear of a vehicle to an object.

### SUMMARY

These and other needs are met by a rear view camera system and a method for calibrating the same.

The rear view camera system provides a video presentation of an area proximate a rear of a vehicle to a driver in a driver's area of the vehicle and includes a video camera, a processor and a video monitor. The video camera is disposed proximate the rear of the vehicle for capturing a video of the area proximate the rear of the vehicle and communicating the video. The processor is for imbedding a calibration rear scale line into the video resulting in a calibration video signal, for receiving user input indicating a desired position for the calibration rear scale line such that the calibration rear scale line coincides with a marker disposed a known distance from the rear of the vehicle, for imbedding a working rear scale line into the video based at least in part on the user input resulting in a working video signal, and for communicating the calibration video signal and the working video signal. The video monitor is disposed proximate the driver's area of the vehicle and receives the calibration video signal and the working video signal. The video monitor displays a calibration presentation based at least in part on the calibration video signal and a working presentation based at least in part on the working video signal. The video monitor may include at least one adjustment button for entering the user input

In some embodiments the video camera comprises the processor and in other embodiments the video monitor comprises the processor. In preferred embodiments, the video monitor displays the calibration presentation when the video monitor receives the calibration video signal and the working presentation when the video monitor receives the working video signal.

In another embodiment of the invention, a method for calibrating a rear view camera system for providing a video presentation of an area proximate a rear of a vehicle to a driver in a driver's area of the vehicle is disclosed. The method includes the steps of (a) capturing a video of the area proximate the rear of the vehicle; (b) imbedding a calibration rear scale line into the video resulting in a calibration video signal; (c) displaying a calibration presentation based at least in part on the calibration video signal; (d) receiving user input indicating a desired position for the calibration rear scale line such that the calibration rear scale line coincides with a marker disposed a known distance from the rear of the vehicle; (e) imbedding a working rear scale line into the video based at least in part on the user input and resulting in a working video signal; and (f) displaying a working presentation based at least in part on the working video signal in view of the driver.

### BRIEF DESCRIPTION OF THE DRAWINGS

Various advantages are apparent by reference to the detailed description in conjunction with the figures, wherein elements are not to scale so as to more clearly show the details, wherein like reference numbers indicate like elements throughout the several views, and wherein:

FIG. 1 is a prior art embodiment of a rear view camera system having multiple rear scale lines incapable of calibration.

FIG. 2 is a block diagram of a typical rear view camera system.

FIG. 3A is a representation of a video monitor mounted in a driver's area.

FIG. 3B is a representation of a video camera mounted proximate the rear of a vehicle.

FIG. 4 is a screenshot of the video monitor displaying an adjustable rear scale line used in the present calibration method.

FIG. 5 is another screenshot of the video monitor displaying the adjustable rear scale line used in the present calibration method.

FIG. 6 is a prospective view of a mounted video monitor in the driver's area of a vehicle, the video monitor showing the calibrated rear scale line.

FIG. 7 is a flowchart of the method for calibrating the rear view camera system.

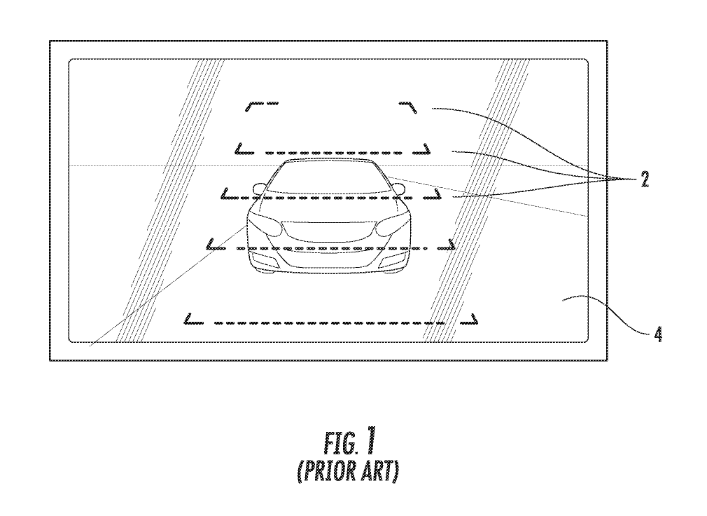

### DETAILED DESCRIPTION

In the following detailed description of the preferred embodiments, reference is made to the accompanying drawings, which form a part hereof, and within which are shown by way of illustration the practice of specific embodiments of the rearview camera system and calibration method. It is to be understood that other embodiments may be utilized, and that structural changes may be made and processes may vary in other embodiments.

A method for calibrating a rear view camera system provides a driver with an accurate and effective aid for backing a vehicle. The rear view camera system includes a closed circuit video camera connected to a video monitor mounted in the driver's area. A marker is placed a known distance from the rear bumper of the vehicle. The system is calibrated by adjusting a horizontal rear scale line up and down on the monitor so that it coincides with the edge of the marker. Once the system is calibrated, as the vehicle is backed and the rear scale line contacts an object on the monitor, the driver knows that the vehicle is the known distance from the rear bumper of the vehicle.

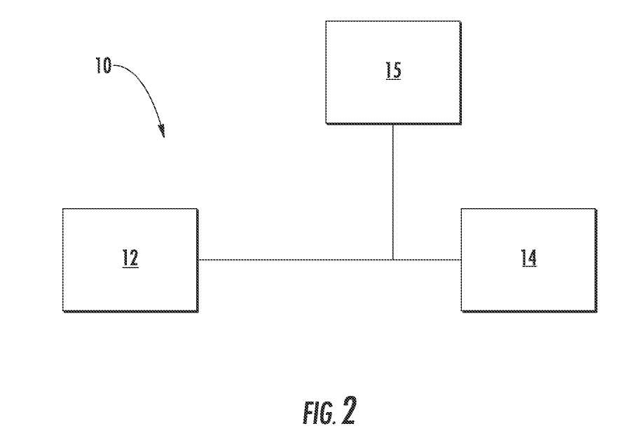

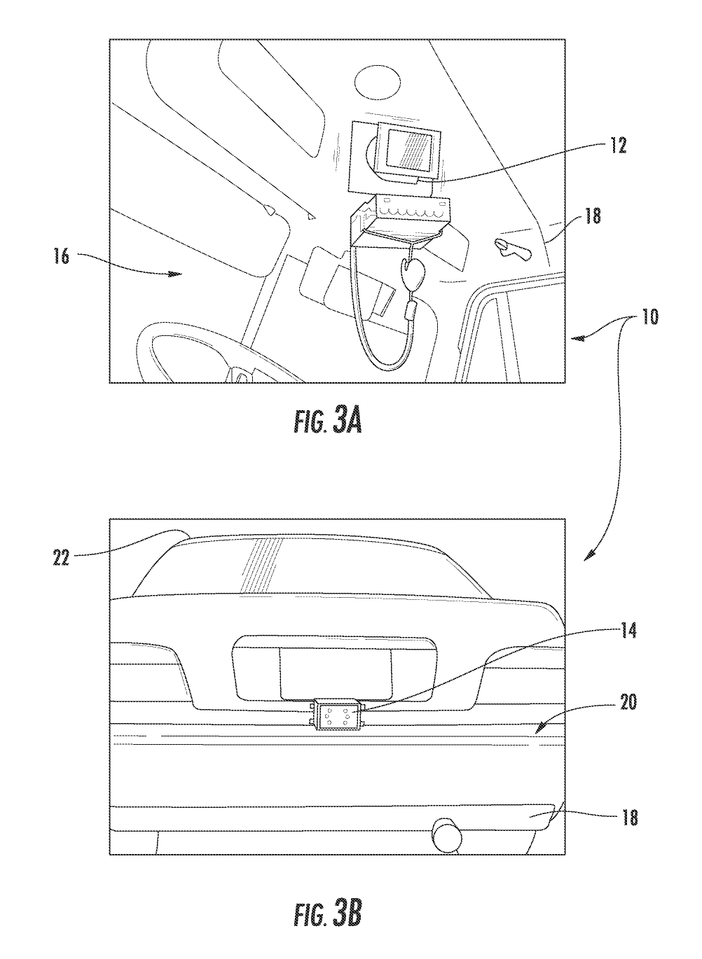

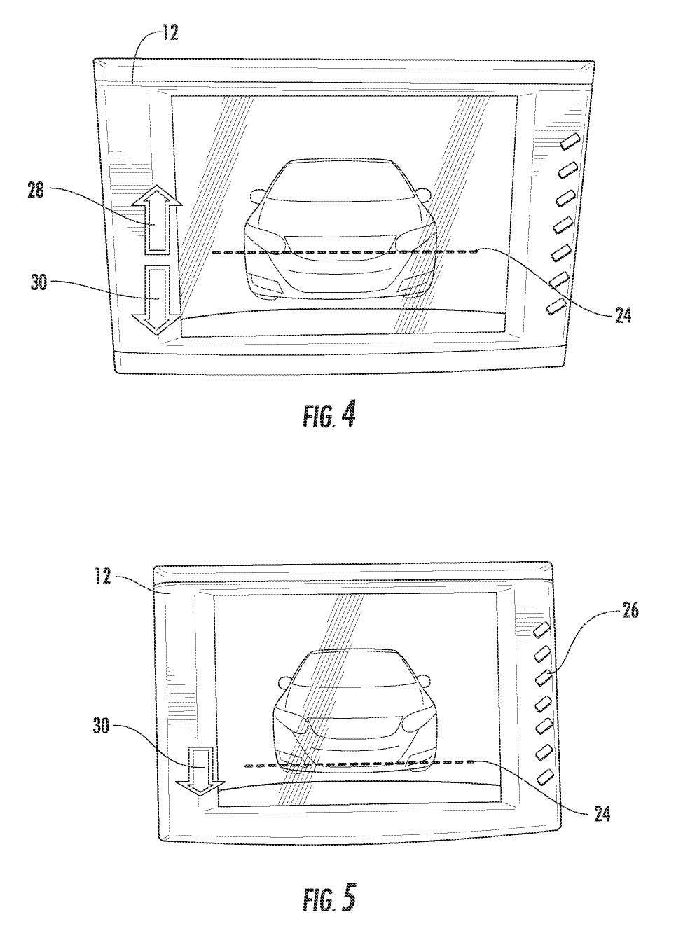

Referring now to FIGS. 2 and 3, the rear view camera system 10 is shown. The system 10 includes a video monitor 12 connected to a closed-circuit video camera 14. The video monitor 12 is mounted in the cabin or driver's area of a vehicle in a location so that the driver can easily view the monitor 12 while backing the vehicle. The video camera 14 is mounted proximate the rear 20 of the vehicle 18, typically near the top 22 of the rear 20 of the vehicle 18 with a line of sight including the rear bumper of the vehicle. In FIG. 2 a processor 15 is connected to the monitor 12 and/or the video camera 14 for processing the signal from the video camera 14 and adding the rear scale line 24 (FIGS. 4-6).

FIGS. 3A and 3B show the two major components of the rear view camera system 10. The interior 16 of a driver's area of a vehicle 18 having a mounted video monitor 12 is shown in FIG. 3A, and the rear 20 of the vehicle 18 is shown in FIG. 3B with a closed-circuit video camera 14 mounted to the rear 20 of the vehicle 18. In preferred embodiments, especially in larger vehicles such as trucks and SUVs, the closed circuit video camera 14 is mounted to the roof 22 of the vehicle 18 such that the camera 14 has a line of sight to the rear 20 of the vehicle 18 and typically including the rear bumper of the vehicle.

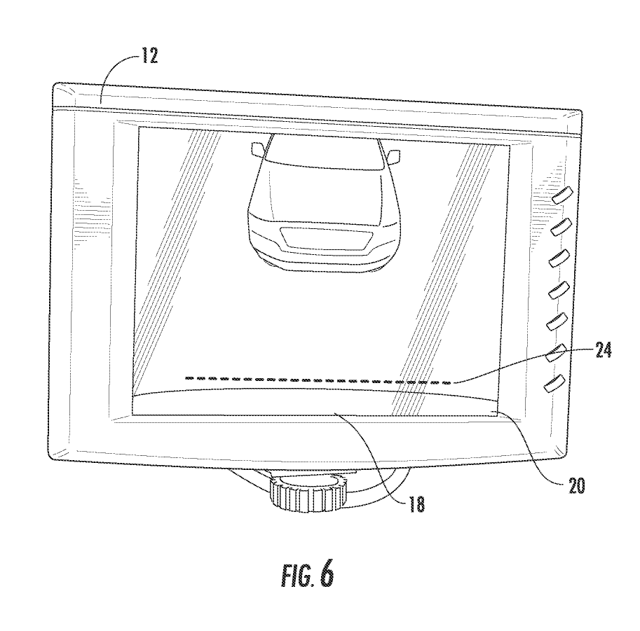

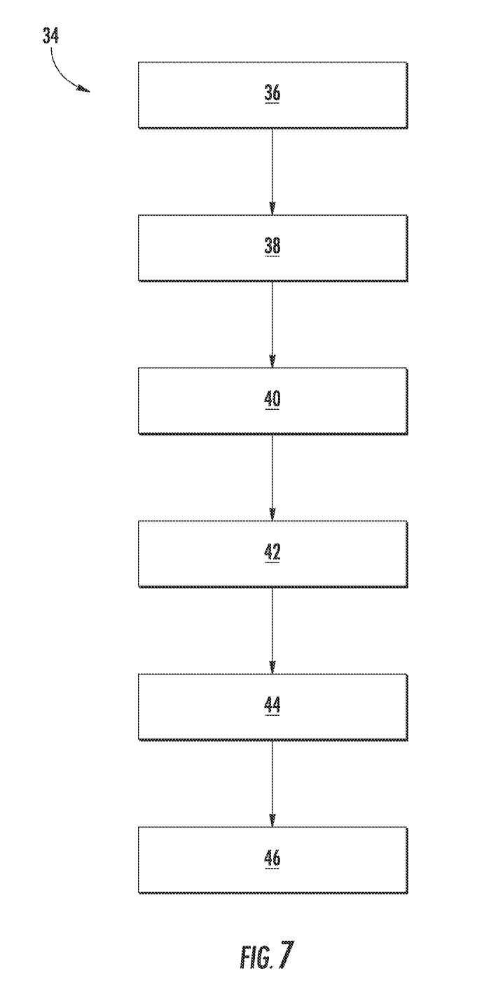

FIGS. 4 and 5 show the video monitor 12 having a rear scale line 24 that is screen-height adjustable. That is, the user can adjust the position of the rear scale line 24 manually by, in one application, using the volume adjustment buttons 26 of the monitor 12. As depicted by arrows 28 and 30, the rear scale line 24 can be adjusted up and down respectively. FIG. 6 shows a monitor 12 mounted in the driver's area of a vehicle 18 with a rear scale line 24 calibrated such that the driver knows the rear scale line 24 represents a fixed distance from the rear bumper of the vehicle 18.

Generally speaking, the video camera 14 is installed at the height it will be used. Next, a distance marker is placed a known distance behind the vehicle 18. Then the video signal from the camera 14 is shown on the monitor 12 with an adjustable rear scale line 24. The rear scale line 24 is adjustable on the monitor 12. The user manually adjusts the rear scale line 24 up or down to coincide with the marker. Then the rear scale line 24 is set by the user indicating to the system 10 the rear scale line 24 is in the desired position on the monitor 12. Finally, the marker is removed and the rear scale line 24 indicates to the driver an accurate, known distance from the rear 20 of the vehicle 18. When the driver is backing the vehicle 18 and the rear scale line 24 coincides with an object, the driver knows the object is the known distance from the rear 20 of the vehicle 18.

The system 10 performs the method 34 of FIG. 7 during calibration of the system 10. First, video of the area proximate the rear 20 of the vehicle 18 is captured by the video camera 14 (step 36). This video typically includes the rear bumper of the vehicle 18 but in some applications it does not. Then, the processor 15 imbeds a calibration rear scale line 24 into the video resulting in a calibration video signal (step 38). Then, the monitor 12 displays a calibration presentation based at least in part on the calibration video signal (step 40). Next, the system 10 accepts input indicating a desired position for the calibration rear scale line 24 such that the calibration rear scale line 24 coincides with a marker disposed a known distance from the rear 20 of the vehicle 18 (step 42). Then the processor imbeds a working rear scale line 24 into the video based at least in part on the user input and resulting in a working video signal (step 44). Finally, the monitor 12 displays a working presentation based at least in part on the working video signal (step 46). The working presentation is typically displayed within view of the driver insider the driver's area or cabin.

The working presentation is the “everyday” mode of operation used after calibration is complete. Using this mode the driver can back his or her vehicle 18 using the rear view camera system 10 and the working rear scale line 24 known to indicate a position a particular distance from the rear 20 of the vehicle 18 thereby reducing incidents of collision with persons, animals or objects positioned behind the driver's vehicle 18.

In some embodiments, multiple video monitors 12 are used having multiple rear scale lines 24 displayed representing various distances from the rear 20 of the vehicle 18. In yet another embodiment, only one video monitor 12 is used, but the calibration method 34 includes multiple iterations of the calibration steps in order to calibrate multiple rear scale lines 24 each representing various distances from the rear 20 of the vehicle 18 and each displayed concurrently on one video monitor 12 during the working presentation mode.

The foregoing descriptions of embodiments have been presented for purposes of illustration and exposition. They are not intended to be exhaustive or to limit the embodiments to the precise forms disclosed. Obvious modifications or variations are possible in light of the above teachings. The embodiments are chosen and described in an effort to provide the best illustrations of principles and practical applications, and to thereby enable one of ordinary skill in the art to utilize the various embodiments as described and with various modifications as are suited to the particular use contemplated. All such modifications and variations are within the scope of the appended claims when interpreted in accordance with the breadth to which they are fairly, legally, and equitably entitled.

What is claimed is:

1. A rear view camera system for providing a video presentation of an area proximate a rear of a vehicle to a driver in a driver's area of the vehicle, the rear view camera system comprising:
a video camera disposed proximate the rear of the vehicle for capturing a video of the area proximate the rear of the vehicle and communicating the video;
a processor for imbedding a calibration rear scale line into the video resulting in a calibration video signal, for receiving user input indicating a desired position for the calibration rear scale line such that the calibration rear scale line coincides with a marker disposed a known distance from the rear of the vehicle, for imbedding a working rear scale line into the video based at least in part on the user input resulting in a working video signal, and for communicating the calibration video signal and the working video signal; and
a video monitor disposed proximate the driver's area of the vehicle for receiving the calibration video signal and the working video signal, and for displaying a calibration presentation based at least in part on the calibration video signal and a working presentation based at least in part on the working video signal.

2. The rear view camera system of claim 1 wherein the video camera comprises the processor.

3. The rear view camera system of claim 1 wherein the video monitor comprises the processor.

4. The rear view system of claim 1 wherein the video monitor displays the calibration presentation when the video monitor receives the calibration video signal and displays the working presentation when the video monitor receives the working video signal.

5. The rear view camera system of claim 1 wherein the video monitor comprises at least one adjustment button for entering the user input.

6. A method for calibrating a rear view camera system for providing a video presentation of an area proximate a rear of a vehicle to a driver in a driver's area of the vehicle, the method comprising:
a. capturing a video of the area proximate the rear of the vehicle;
b. imbedding a calibration rear scale line into the video resulting in a calibration video signal;
c. displaying a calibration presentation based at least in part on the calibration video signal;
d. receiving user input indicating a desired position for the calibration rear scale line such that the calibration rear scale line coincides with a marker disposed a known distance from the rear of the vehicle;
e. imbedding a working rear scale line into the video based at least in part on the user input and resulting in a working video signal; and
f. displaying a working presentation based at least in part on the working video signal in view of the driver.

7. A method for calibrating a rear view camera system for providing a video presentation of an area proximate a rear of a vehicle to a driver in a driver's area of the vehicle, the method comprising:
a. means for capturing a video of the area proximate the rear of the vehicle;
b. means for imbedding a calibration rear scale line into the video resulting in a calibration video signal;
c. means for displaying a calibration presentation based at least in part on the calibration video signal;
d. means for receiving user input indicating a desired position for the calibration rear scale line such that the calibration rear scale line coincides with a marker disposed a known distance from the rear of the vehicle;
e. means for imbedding a working rear scale line into the video based at least in part on the user input and resulting in a working video signal; and
f. means for displaying a working presentation based at least in part on the working video signal in view of the driver.
